(19) United States
(12) Patent Application Publication
(10) Pub. No.: US 2024/0370699 A1
(43) Pub. Date: Nov. 7, 2024

(54) DATA PRE-FETCH FOR LARGE LANGUAGE MODEL (LLM) PROCESSING

(71) Applicant: Intel Corporation, Santa Clara, CA (US)

(72) Inventors: Duane E. GALBI, Wayland, MA (US); Matthew Joseph ADILETTA, Bolton, MA (US); Matthew James ADILETTA, Bolton, MA (US)

(21) Appl. No.: 18/764,802

(22) Filed: Jul. 5, 2024

(51) Int. Cl. G06N 3/045

(52) U.S. Cl. CPC G06N 3/045

(57) ABSTRACT

Examples described herein relate to a processor to process constant weight values and key value entries associated with a first transformer kernel of a large language model (LLM) neural network and a circuitry. The circuitry is to: during processing of the constant weight values and key value entries associated with the first transformer kernel of the LLM neural network, pre-fetch constant weight values and key value entries associated with a second transformer kernel of the LLM neural network into a buffer.

### BACKGROUND

Large language models (LLMs) represent a class of deep learning architectures called transformer models. A transformer model is a neural network that learns context and meaning by tracking relationships in sequential data, such as words in a sentence. A transformer is made up of multiple transformer blocks, also known as layers. A transformer layer has a self-attention kernel, a feed-forward kernel, and normalization kernels. An output of a transform layer is an input to the next transformer layer. Transformer layers work together to decipher inputs to predict streams of outputs at inference.

Data (e.g., constant weights and key value (KV) cache entries), used by each layer, is unique to that layer. Within a transformer layer, a KV cache is updated to supply data for the next iteration of that layer during the next iteration of the transformer model. The size of data used by a layer can be calculated from the size of the transformer model. For example, in a 200-billion parameter transformer model with one-hundred layers using a two-byte parameter size, the sum of the size of the weights for each layer is four gigabytes and the size of the KV-cache is approximately 100 megabytes (with 4096 sequence length).

Transformer attention and feed forward layer kernels perform matrix multiplication operations. For example, for the GPT-J LLM model, for the attention kernel, weight matrices are applied, such as wQ, wK, wV, and wO. These matrices are multiplied with the input to produce intermediate data matrices (e.g., query, key, and value data matrices), which are then used to calculate attention scores. The feed forward kernel includes large matrix multiplication denoted as w1_g and w2, where an activation function is fused with the w1 matrix multiplication.

### BRIEF DESCRIPTION OF THE DRAWINGS

FIG. 1 depicts an example system.

FIG. 2A depicts an example system.

FIG. 2B depicts examples of layer buffers.

FIGS. 3A-3C depict examples of data copying.

FIG. 4 depicts an example of memory bandwidth utilizations.

FIGS. 5A-5D depict example graphics processing units.

FIG. 6 depicts an example process.

FIG. 7 depicts an example system.

### DETAILED DESCRIPTION

An LLM inference procedure can include a prefill phase (e.g., first token) and token decode phase (e.g., second token). During the prefill phase, the model processes a prompt and creates the KV cache during self-attention. The prefill phase can be compute intensive from processing tokens in the prompt and their subsequent storage in the KV cache. The KV cache stores the model's context and the context can be used to generate future tokens. The attention kernel of the prefill phase performs an intermediate quadratic calculation with the sequence length.

During the token decode phase, instead of processing an extensive sequence of prompts, the most recently generated token is input into the LLM. The LLM performs a series of vector-matrix multiplications, and the speed of this phase can be constrained by available bandwidth, rather than computational capacity. The LLM uses the context stored in the KV cache to generate new tokens. The LLM adds a new token to the KV cache to update the context. This process continues, with new tokens being influenced by the updated context in the KV cache. The LLM uses this continually updated context to generate a coherent and contextually appropriate sequence of tokens.

In the token prefill and token generation phases, the KV cache stores the context based on generation of new tokens. The LLM can reference the KV cache to determine a next token, rather than having to process the entire input again. Multiple compute sockets can be used to satisfy compute-based latency requirements or to hold the weights and data in memory, but can experience network latency, such as where intermediate calculations are performed across compute units coupled by a network. During network operations, periods of low memory-bandwidth utilization can occur due to the serialized nature of LLM kernels. Synchronization time, thread scheduling overhead time, and other low bandwidth phases can limit the average bandwidth utilization of the memory-bound decode phase.

A forward pass of a “mixed token” LLM serving engine can be compute bound during weight matrix multiply, and memory bandwidth bound when reading KV cache during decode token attention. Specifically, during compute bound regions, the memory bandwidth utilization can be relatively low, and during the memory bandwidth bound regions, the compute utilization can be relatively low. This can lead to low average system utilization of both compute and memory bandwidth.

LLMs may utilize multiple compute sockets to satisfy latency-based compute requirements or to store the weights and data in external memory. In a multi-node scenarios, network transfers can occur between graphics processing units (GPUs) whereby outputs of the attention kernel and the outputs of the feed forward kernel are reduced across the GPUs. Reduction can involve network operations AllReduce (a_r) and AllGather (a_g).

At least to attempt to increase system utilization of compute resources despite limitations in memory bandwidth, various examples include a processor, such as a graphics processing unit (GPU) or central processing unit (CPU), that processes data of a kernel of an LLM and a circuitry prefetches data for a next kernel into a buffer and then the LLM processes data for the next kernel from the buffer. Various examples fetch data from a memory subsystem during network communication phase and fetch data during synchronization times and other more serial parts of the LLM. To meet peak bandwidth requirements of the LLM, data can be sourced from the layer buffer, rather than from the memory subsystem. More specifically, during compute-bound regions, network-bound regions, and serial regions of the application, prefetching of layer data from external memory into the layer buffer can occur, utilizing available low bandwidth. During the Attention phase, the processors process layer data from the layer buffer at a significantly higher bandwidth, thereby reducing latency of completing the Attention phase. For a layer that includes multiple kernels, various examples can pre-fetch data associated with one or more kernels of a same layer or one or more kernels of one or more next layers.

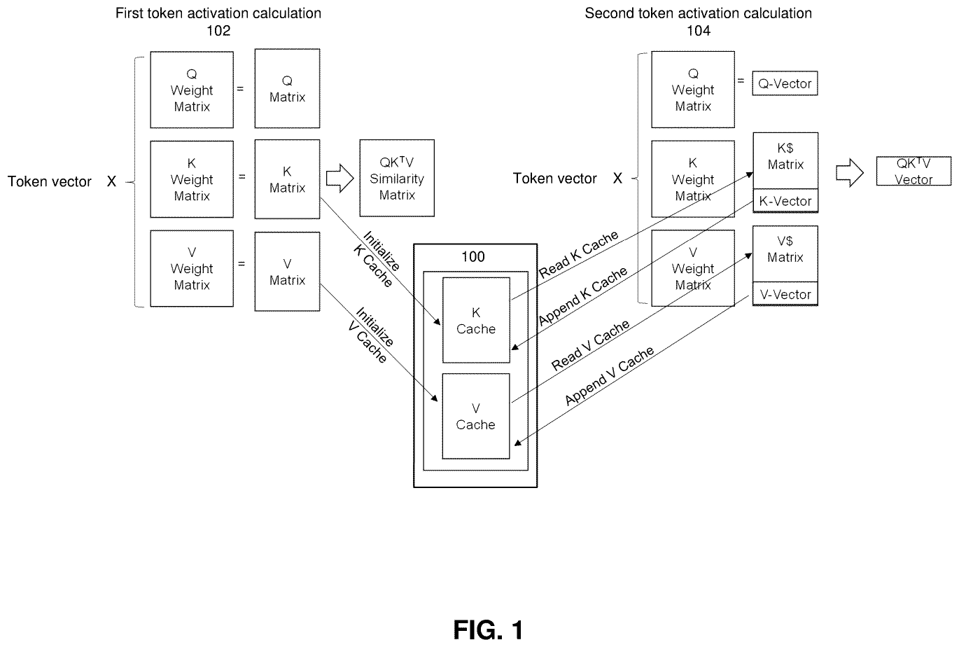

FIG. 1 depicts an example of calculations of token activations. According to Vaswani, A. et. al., “Attention is All you Need” Advances in Neural Information Processing Systems 30: Annual Conference on Neural Information Processing Systems 2017 (December 2017), attention can be calculated as follows:

$$\\ Attention ( Q , K , V ) = softmax ( \frac{{QK}^{{}_{} T}}{\sqrt{{d}_{k}}} ) V$$

where WQi, WKi, and WVi are parameters learned by standard back-propagation.
In some examples, calculated Q, key (K), and value (V) weights can be stored in KV cache 100. Based on an input token matrix, first token activation calculations 102 of Q, K, and V values can be stored into KV cache 100. Based on reading K and V values from first token activation calculations 102, second token activation calculations 104 of Q, K, and V values can be appended into KV cache 100.

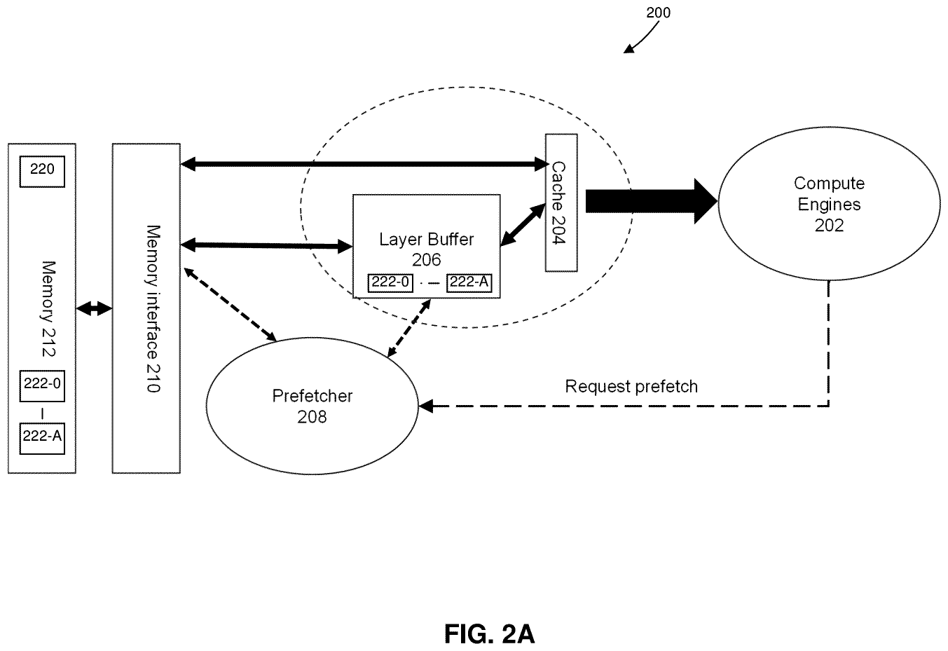

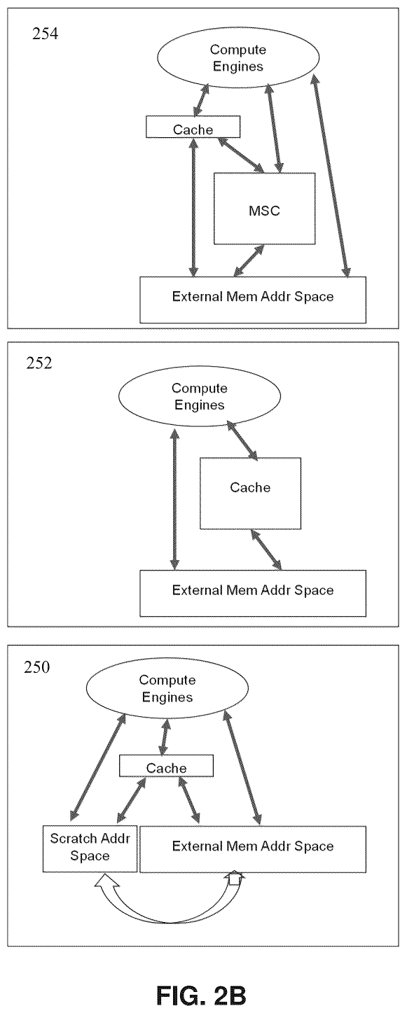

FIG. 2A depicts an example system. System 200 can be utilized by one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. Compute engines 202 can request data 220 from memory 212 and process data 220 in cache 204. Cache 204 can include one or more of: one or more registers, one or more cache devices (e.g., level 1 cache (L1), level 2 cache (L2), level 3 cache (L3), last level cache (LLC)), volatile memory device, non-volatile memory device, or persistent memory device.

As described herein, an operating system (OS), driver, or compute engines 202 can configure prefetcher 208 to prefetch data 222 from memory 212 into layer buffer 206. Prefetcher 208 can stage data 222 in layer buffer 206 before data 222 is processed by compute engines 202. Prefetcher 208 can prefetch weight matrices and key-value cache from memory 212 into layer buffer 206. Consequently, during a decode phase, compute engines 202 read weight matrices and key-value cache from layer buffer 206, reducing latency of the vector-matrix multiply. Compute engines 202 and/or prefetcher 208 can include one or more of: an FPGA, accelerator, ASIC, or instruction-executing processor. Prefetcher 208 can be integrated into compute engines 202 or implemented as an offload engine from compute engines 202.

Layer buffer 206 can be implemented as one or more of: a register, a cache device, volatile memory device, non-volatile memory device, or persistent memory device. Memory 212 can include one or more of: volatile memory, non-volatile memory, volatile memory device, non-volatile memory device, or persistent memory device. Memory 212 can include one or more of: static random access memory (SRAM) memory technology or memory technology consistent with high bandwidth memory (HBM), or double data rate (DDR), among others.

During at least the attention phases of an LLM, data 220 and prefetched data 222 can include constant values of layers of an LLM. For example, compute engines 202 can perform kernels (e.g., wQ, wK, wV, sdpa[Attention], wO, a_r, a_g, w_1g, w2, a_r, a_g). For example, while processing data 220 of a first layer, compute engines 202 can request prefetcher 208 to prefetch one or more of data 222-0 to 222-A, where A is an integer. Data 222-0 to 222-A can be associated with one or more subsequent layers or kernels. Compute engines 202 can determine which of data 222-0 to 222-A to prefetch based on a next layer of the transformer model to process or data predicted to be accessed subsequently based on prior patterns of data fetches. Compute engines 202 and/or prefetcher 208 can mark data in layer buffer 206 as read-only or read-write.

For example, during the token generation phase, compute engines 202 can process wQ and wK from data 222-0 to 222-A in layer buffer 206, while the wV, sdpa[Attention], and sO are prefetched from memory 212. Prefetcher 208 and/or compute engines 202 can perform format conversions for data 220 and 222, such as per-vector scaled quantization (VSQ) and the microscaling (MX) format prior to input and or after output from layer buffer 206 to layer buffer 206.

During network bandwidth bound regions, prefetcher 208 can prefetch weight matrices and key-value cache from memory 212 into layer buffer 206. Consequently, during the decode phase, compute engines 202 read weight matrices and key-value cache from layer buffer 206, reducing the vector-matrix multiply latency.

In a mixed token batching stream, compute engines 202 can process multiple streams at the same time. Constant weight values (e.g., W values) of multiple streams can repeat and compute engines 202 can process constant weight values of multiple streams from constant weight values (e.g., K or V values) of a single stream in cache 204. In some cases, KV values for multiple streams can be unique for different streams. For example, if an integer N number of streams are batched together, a size of KV cache data can be increased by N times but an amount of memory to store the constants weight data can be unchanged. For example, in a 200-billion parameter transformer model with one-hundred layers using a two-byte parameter size and a 4096 sequence length, the aggregate KV cache sizes per layer could be 4 gigabytes, but size of the weights for each layer can be unchanged. In this case, layer buffer 206 could be approximately 8 gigabytes in size for a single socket, and 4 gigabytes for a two-socket system.

By prefetching data into layer buffer 206, layer buffer 206 can supply a bandwidth gap between the bandwidth supported from memory 212 and memory bandwidth that would utilize compute engines 202 and reduce idleness of compute engines 202. In other words, layer buffer 206 can bridge a bandwidth gap when memory bandwidth of interface 210 does not match capabilities of processing bandwidth of compute engines 202.

In some examples, prefetcher 208 can prefetch data 222-0 to 222-A, as an entirety of a KV cache for an entire transformer model, into layer buffer 206. Prefetcher 208 and/or compute engines 202 can read KV cache data from layer buffer 206 and write updated KV cache data into layer buffer 206. A remainder of layer buffer 206 can be dynamically allocated for layer specific data, such as constant weight matrix data. In this configuration, prefetcher 208 and/or compute engines 202 can read constant weight matrix data from memory 212.

A kernel can include one or more operations. While compute engines 202 perform first operations of a first kernel, prefetcher 208 can prefetch data for: a second operation of the first kernel or one or more operations of the first kernel, one or more operations of a second kernel or other kernel, or operations of the first kernel and one or more kernels.

Various examples of operations include at least: forward pass, compute loss, backward pass, error function, loss function, update weights, ReduceScatter, AllGather, or others. Examples of forward pass or forward propagation can calculate a model's predictions with true values or train data from input layer to output layer. Examples of backward pass or backward propagation can calculate a gradient using an average of a sum of losses or differences between the model's predictions and true values or train data, from output layer to input layer. Examples of an error function or loss function can include determination of one or more of: Mean Square Error (MSE)/L2 loss, Mean Absolute Error (MAE)/L1 loss, binary cross-entropy loss/log loss, categorical cross-entropy loss, hinge loss, huber loss/smooth mean absolute error, or log loss.

Memory interface 210 can communicatively couple memory 212 to at least cache 204, compute engines 202, and layer buffer 206. Memory interface 210 can provide access to memory 212 in accordance with various protocols such as memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), DDR5 (JESD79-5 DDR5 SDRAM (July 2020)), LPDDR5 (JESD209-5 (February 2019)), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), or others or combinations of memory technologies, and technologies based on derivatives or extensions of such specifications.

Memory bandwidth of memory interface 210 to memory 212 can be allocated for an average expected bandwidth rather than a peak bandwidth to reduce memory bandwidth to achieve a particular bandwidth. Compute engines 202 can access prefetched data 222-0 to 222-A from layer buffer 206 with an approximately uniform access latency. However, memory 212 can be composed of composite memory devices with different latencies based on different address regions that store data 220 or data 222-0 to 222-A so that memory bandwidth allocated to the different address regions can be varied. Examples can reduce the impact of the memory bandwidth bottleneck of memory interface 210 during attention of mixed token query serving systems and allow for improving overall utilization of compute engines 202.

In some examples, matrix sparsity recognition can be used to reduce allocated memory bandwidth of memory interface 210 where non-zero data elements are transferred over memory interface 210. A sparse matrix can include a number of zero elements that is more than a number of non-zero elements and sparse matrices may store only the nonzero elements and their row indices.

A size of layer buffer 206 can be approximately the size of data associated with a layer. For example, a portion of layer buffer 206 can be allocated to store layer data that is being processed (e.g., data 222-0) processed by compute engines 202 and a second portion can be allocated to store prefetched data (e.g., data 222-A) of a next layer. Hence, for a 200 billion 2-bytes parameter model with roughly 200 layers, the total layer buffer could be approximately 4 gigabytes (GB) in size. The size of the layer per socket can be the total size of the layer buffer divided by the number of sockets used. For example, in a two-socket system, a 2 GB layer buffer can be allocated per socket.

In some examples, a size of layer buffer 206 can be two times a size of the data used during processing of a transformer layer. Data for the current processing layer could be read from one half of layer buffer 206, while data being fetched for the next layer could be written into the other half of layer buffer 206.

Memory 212 can be accessed as a local device or a remote memory pool through a device interface (e.g., Compute Express Link (CXL) or Peripheral Component Interconnect express (PCIe)), switch, or network. Memory 212 can be shared by multiple servers or processors. Memory 212 can include at least two levels of memory (alternatively referred to herein as “2 LM” or tiered memory) can be used that includes cached subsets of system disk level storage (in addition to, for example, run-time data). This main memory includes a first level (alternatively referred to herein as “near memory”) including lower latency and/or higher bandwidth memory made of, for example, dynamic random access memory (DRAM) or other volatile memory; and a second level (alternatively referred to herein as “far memory”) which includes higher latency and/or lower bandwidth (with respect to the near memory) volatile memory (e.g., DRAM) or nonvolatile memory storage (e.g., flash memory or byte addressable non-volatile memory (e.g., Intel Optane®)). The far memory can be presented as “main memory” to the host operating system (OS), while the near memory can include a cache for the far memory that is transparent to the OS. The management of the two-level memory may be performed by a combination of circuitry and modules executed via the host central processing unit (CPU). Near memory may be coupled to the host system CPU via high bandwidth, low latency connection for low latency of data availability. Far memory may be coupled to the CPU via low bandwidth, high latency connection (as compared to that of the near memory), via a network or fabric, or a similar high bandwidth, low latency connection as that of near memory. Far memory devices can exhibit higher latency or lower memory bandwidth than that of near memory. For example, Tier 2 memory can include far memory devices and Tier 1 can include near memory.

In some examples, regions of memory 212 can be allocated by a call to an application program interface (API) as memory as a service (MaaS) to rent use of memory.

FIG. 2B depicts examples of layer buffers. According to configuration 250, layer buffer can be implemented as part of scratch-pad memory space in main memory (e.g., memory 212). According to configuration 252, layer buffer can be implemented as part of cache (e.g., cache 204). According to configuration 254, layer buffer can be implemented as part of memory-side-cache (MSC).

In configuration 250, the external memory data is first prefetched to a scratch-pad address space before it is read by compute engines. The scratch-pad memory could be implemented as a high-bandwidth memory structure in a same socket as that of the compute engines. When scratch-pad memory data are cached in a cache and in the compute engines, when the data is moved from the memory address space to the scratch-pad address space, the cache and the caching hierarchy can be updated to maintain the data consistency of the scratch pad address space.

In configuration 252, a layer buffer may be implemented as part of a cache. In this case, data could be prefetched from memory interface into the cache. A tag of addresses associated with data stored in the cache can be stored to achieve data coherency when the data is stored in multiple devices. Furthermore, where data stored in the cache is at least partially inclusive to the data stored in the compute engines, adding data to the cache and evicting previously stored data in the cache, can cause caching hierarchy to be updated to update tracking of partial exclusivity of the cache relative to the rest of the caching hierarchy.

In configuration 254, layer buffer may be implemented as a memory side cache (MSC). An MSC can be a source of data but not participate in a data coherency protocol. A tag of addresses associated with data stored in the MSC can be stored. However, the MSC can store data that is non-exclusive to the cache and the rest of the caching hierarchy. Hence, unlike the scratch-pad memory or the cache layer buffer, the cache or the rest of the caching hierarchy may not be updated when an entry is added to the MSC or removed from the MSC.

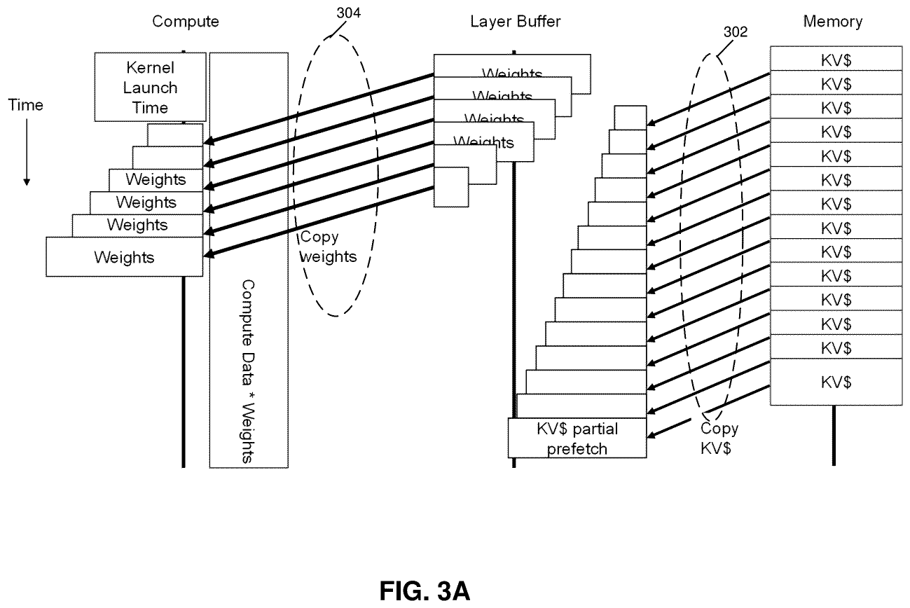

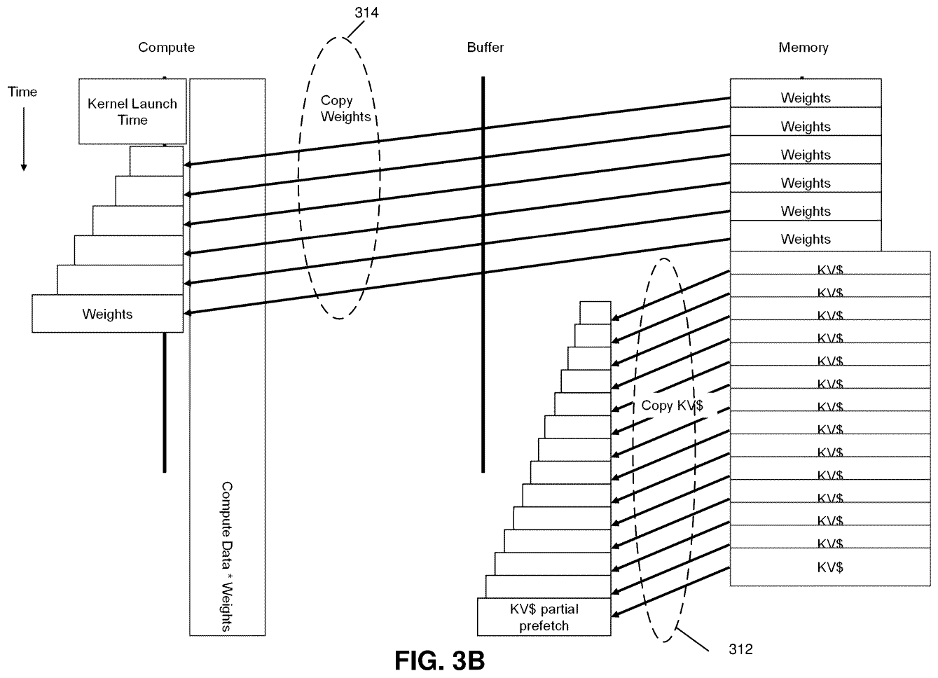

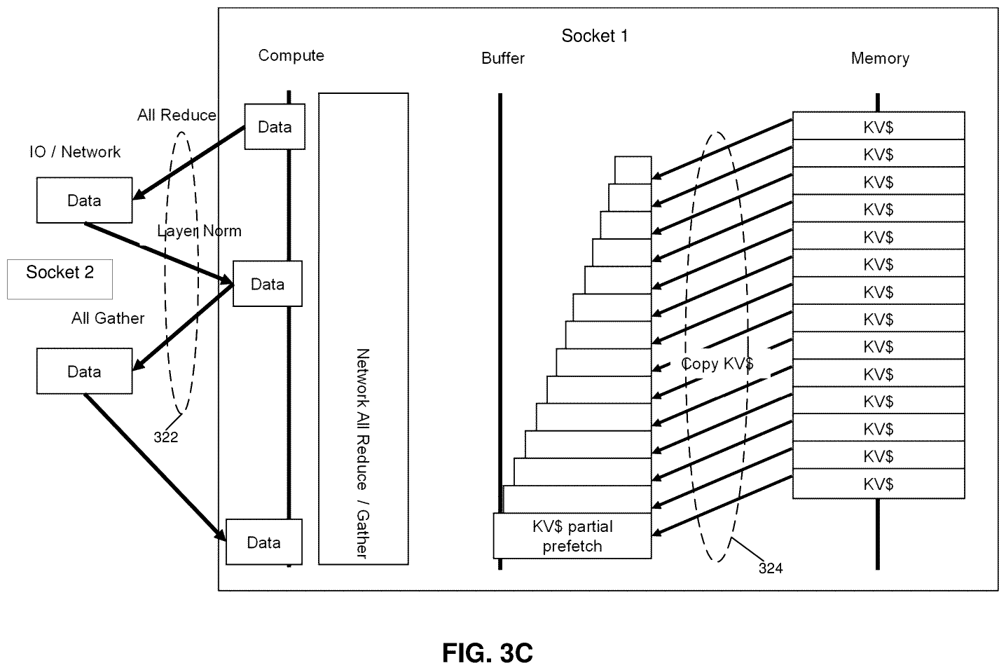

FIGS. 3A-3C depict examples of data copying. FIG. 3A depicts an example of copying weights from a layer buffer to a cache for processing by compute engines, at 304, overlapping in time with copying KV data of one or more subsequent kernels from memory into the layer buffer to fill the layer buffer, at 302.

FIG. 3B depicts an example of copying weights from memory to a cache for processing by compute engines, at 314, overlapping in time with copying KV data of one or more subsequent kernels from memory into the layer buffer, at 312, to fill the layer buffer. This example can utilize less power compared to the example of FIG. 3A.

FIG. 3C depicts an example of copying data via a network to a second processor socket (e.g., socket 2) for processing by compute engines of the second processor socket, at 322, overlapping in time with copying KV data of one or more subsequent kernels from memory into the layer buffer, at 324, to fill the layer buffer.

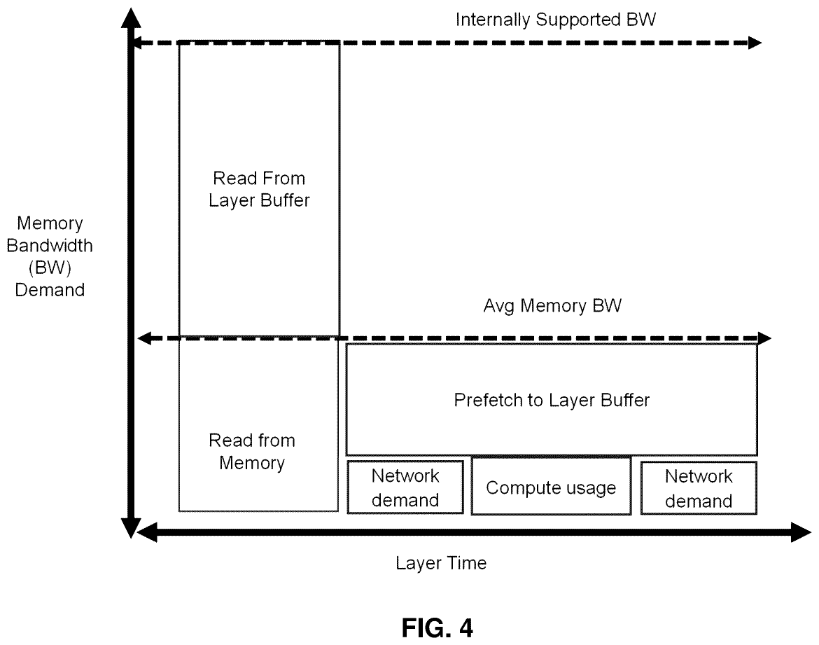

FIG. 4 depicts an example of memory bandwidth utilization. As shown, internally supported bandwidth (BW) line represents an amount of memory bandwidth to saturate the internal processing capability of the compute engines that perform kernels associated with the transformer layer. The Avg Memory BW line shows an amount of external bandwidth (“BW”) needed if the external memory bandwidth was averaged over the full layer time using a layer buffer. The height of the box labeled Read from layer buffer can represent bandwidth from the layer buffer to execute the transformer layer at the full internally supported BW. Layer Time can represent data copy operations during processing of a layer, namely, Read data from Memory and Prefetch to Layer Buffer. During Prefetch to Layer Buffer, network demand can peak, followed by compute usage, and followed again by network demand.

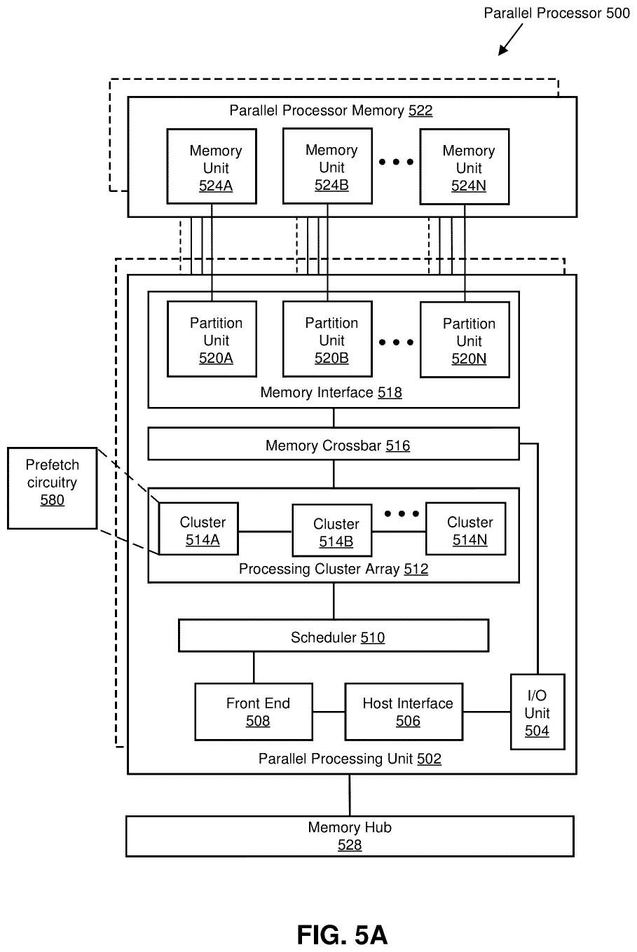

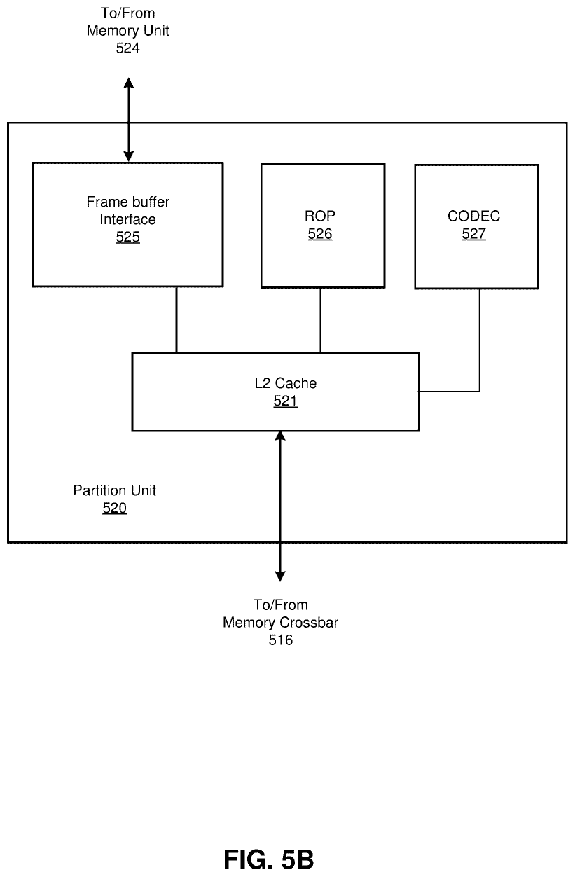

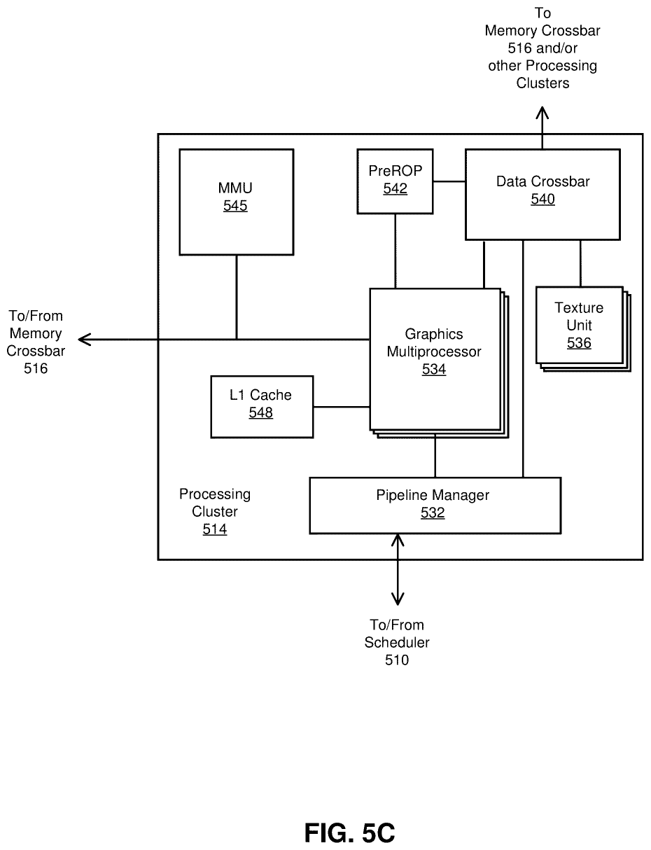

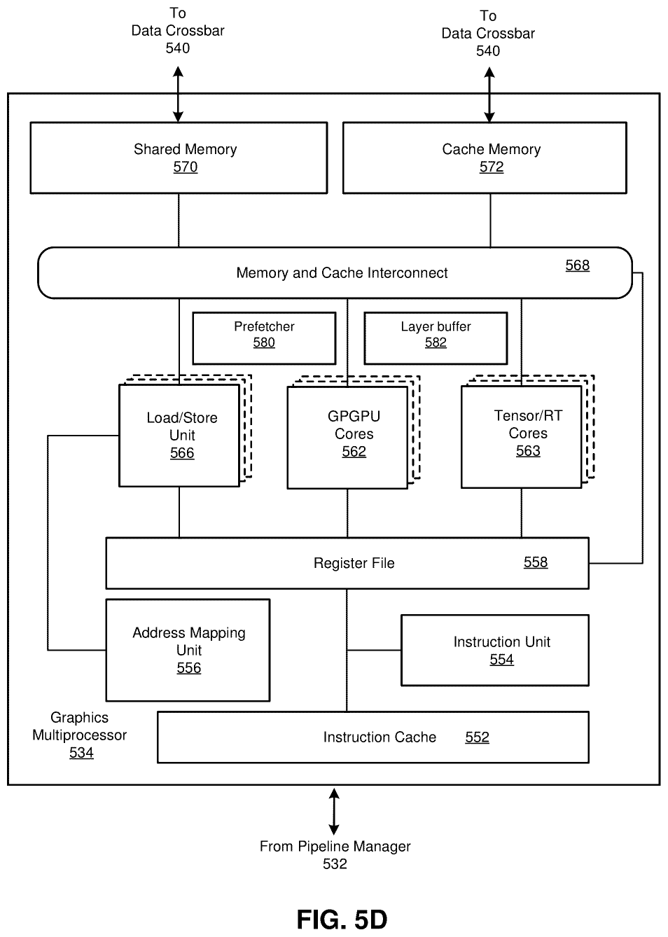

FIGS. 5A-5D depict example GPU compute components. FIG. 5A illustrates a parallel processor 500. The parallel processor 500 may be a GPU, GPGPU or the like as described herein. The various components of the parallel processor 500 may be implemented using one or more integrated circuit devices, such as programmable processors, application specific integrated circuits (ASICs), or field programmable gate arrays (FPGA).

The parallel processor 500 includes a parallel processing unit 502. The parallel processing unit includes an I/O unit 504 that enables communication with other devices, including other instances of the parallel processing unit 502. The I/O unit 504 may be directly connected to other devices. For instance, the I/O unit 504 connects with other devices via the use of a hub or switch interface, such as a memory hub. The connections between memory hub 528 and the I/O unit 504 form a communication link. Within the parallel processing unit 502, the I/O unit 504 connects with a host interface 506 and a memory crossbar 516, where the host interface 506 receives commands directed to performing processing operations and the memory crossbar 516 receives commands directed to performing memory operations.

When the host interface 506 receives a command buffer via the I/O unit 504, the host interface 506 can direct work operations to perform those commands to a front end 508. In one embodiment the front end 508 couples with a scheduler 510, which is configured to distribute commands or other work items to a processing cluster array 512. The scheduler 510 configures processing cluster array 512 is properly configured and in a valid state before tasks are distributed to the processing clusters of the processing cluster array 512. The scheduler 510 may be implemented via firmware logic executing on a microcontroller. The microcontroller implemented scheduler 510 is configurable to perform complex scheduling and work distribution operations at coarse and fine granularity, enabling rapid preemption and context switching of threads executing on the processing cluster array 512. Preferably, the host software can prove workloads for scheduling on the processing cluster array 512 via one of multiple graphics processing doorbells. In other examples, polling for new workloads or interrupts can be used to identify or indicate availability of work to perform. The workloads can then be automatically distributed across the processing cluster array 512 by the scheduler 510 logic within the scheduler microcontroller.

The processing cluster array 512 can include up to “N” processing clusters (e.g., cluster 514A, cluster 514B, through cluster 514N). At least one of cluster 514A-514N of the processing cluster array 512 can execute a large number of concurrent threads. The scheduler 510 can allocate work to the clusters 514A-514N of the processing cluster array 512 using various scheduling and/or work distribution algorithms, which may vary depending on the workload arising for a type of program or computation. The scheduling can be handled dynamically by the scheduler 510 or can be assisted in part by compiler logic during compilation of program logic configured for execution by the processing cluster array 512. Optionally, different clusters 514A-514N of the processing cluster array 512 can be allocated for processing different types of programs or for performing different types of computations.

The processing cluster array 512 can be configured to perform various types of parallel processing operations. For example, the processing cluster array 512 is configured to perform general-purpose parallel compute operations. For example, the processing cluster array 512 can include logic to execute processing tasks including filtering of video and/or audio data, performing modeling operations, including physics operations, and performing data transformations.

The processing cluster array 512 is configured to perform parallel graphics processing operations. In such embodiments in which the parallel processor 500 is configured to perform graphics processing operations, the processing cluster array 512 can include additional logic to support the execution of such graphics processing operations, including, but not limited to texture sampling logic to perform texture operations, as well as tessellation logic and other vertex processing logic. Additionally, the processing cluster array 512 can be configured to execute graphics processing related shader programs such as, but not limited to vertex shaders, tessellation shaders, geometry shaders, and pixel shaders. The parallel processing unit 502 can transfer data from system memory via the I/O unit 504 for processing. During processing the transferred data can be stored to on-chip memory (e.g., parallel processor memory 522) during processing, then written back to system memory.

In embodiments in which the parallel processing unit 502 is used to perform graphics processing, the scheduler 510 may be configured to divide the processing workload into approximately equal sized tasks, to better enable distribution of the graphics processing operations to multiple clusters 514A-514N of the processing cluster array 512. In some of these embodiments, portions of the processing cluster array 512 can be configured to perform different types of processing. For example, a first portion may be configured to perform vertex shading and topology generation, a second portion may be configured to perform tessellation and geometry shading, and a third portion may be configured to perform pixel shading or other screen space operations, to produce a rendered image for display. Intermediate data produced by one or more of the clusters 514A-514N may be stored in buffers to allow the intermediate data to be transmitted between clusters 514A-514N for further processing.

During operation, the processing cluster array 512 can receive processing tasks to be executed via the scheduler 510, which receives commands defining processing tasks from front end 508. For graphics processing operations, processing tasks can include indices of data to be processed, e.g., surface (patch) data, primitive data, vertex data, and/or pixel data, as well as state parameters and commands defining how the data is to be processed (e.g., what program is to be executed). The scheduler 510 may be configured to fetch the indices corresponding to the tasks or may receive the indices from the front end 508. The front end 508 can configure the processing cluster array 512 to a valid state before the workload specified by incoming command buffers (e.g., batch-buffers, push buffers, etc.) is initiated.

At least one of the one or more instances of the parallel processing unit 502 can couple with parallel processor memory 522. The parallel processor memory 522 can be accessed via the memory crossbar 516, which can receive memory requests from the processing cluster array 512 as well as the I/O unit 504. The memory crossbar 516 can access the parallel processor memory 522 via a memory interface 518. The memory interface 518 can include multiple partition units (e.g., partition unit 520A, partition unit 520B, through partition unit 520N) that can couple to a portion (e.g., memory unit) of parallel processor memory 522. The number of partition units 520A-520N may be configured to be equal to the number of memory units, such that a first partition unit 520A has a corresponding first memory unit 524A, a second partition unit 520B has a corresponding second memory unit 524B, and an Nth partition unit 520N has a corresponding Nth memory unit 524N. In other embodiments, the number of partition units 520A-520N may not be equal to the number of memory devices.

The memory units 524A-524N can include various types of memory devices, including dynamic random-access memory (DRAM) or graphics random access memory, such as synchronous graphics random access memory (SGRAM), including graphics double data rate (GDDR) memory. Optionally, the memory units 524A-524N may also include 3D stacked memory, including but not limited to high bandwidth memory (HBM). Persons skilled in the art will appreciate that the specific implementation of the memory units 524A-524N can vary and can be selected from one of various conventional designs. Render targets, such as frame buffers or texture maps may be stored across the memory units 524A-524N, allowing partition units 520A-520N to write portions of a render target in parallel to efficiently use the available bandwidth of parallel processor memory 522. In some embodiments, a local instance of the parallel processor memory 522 may be excluded in favor of a unified memory design that utilizes system memory in conjunction with local cache memory.

Optionally, any one of the clusters 514A-514N of the processing cluster array 512 has the ability to process data that will be written to any of the memory units 524A-524N within parallel processor memory 522. The memory crossbar 516 can be configured to transfer the output of at least one of cluster 514A-514N to any partition unit 520A-520N or to another cluster 514A-514N, which can perform additional processing operations on the output. At least one of cluster 514A-514N can communicate with the memory interface 518 through the memory crossbar 516 to read from or write to various external memory devices. In one of the embodiments with the memory crossbar 516 the memory crossbar 516 has a connection to the memory interface 518 to communicate with the I/O unit 504, as well as a connection to a local instance of the parallel processor memory 522, enabling the processing units within the different processing clusters 514A-514N to communicate with system memory or other memory that is not local to the parallel processing unit 502. Generally, the memory crossbar 516 may, for example, be able to use virtual channels to separate traffic streams between the clusters 514A-514N and the partition units 520A-520N.

While a single instance of the parallel processing unit 502 is illustrated within the parallel processor 500, any number of instances of the parallel processing unit 502 can be included. For example, multiple instances of the parallel processing unit 502 can be provided on a single add-in card, or multiple add-in cards can be interconnected. For example, the parallel processor 500 can be an add-in device, which may be a graphics card such as a discrete graphics card that includes one or more GPUs, one or more memory devices, and device-to-device or network or fabric interfaces. The different instances of the parallel processing unit 502 can be configured to inter-operate even if the different instances have different numbers of processing cores, different amounts of local parallel processor memory, and/or other configuration differences. Optionally, some instances of the parallel processing unit 502 can include higher precision floating point units relative to other instances. Systems incorporating one or more instances of the parallel processing unit 502 or the parallel processor 500 can be implemented in a variety of configurations and form factors, including but not limited to desktop, laptop, or handheld personal computers, servers, workstations, game consoles, and/or embedded systems. An orchestrator can form composite nodes for workload performance using one or more of: disaggregated processor resources, cache resources, memory resources, storage resources, and networking resources.

While parallel processing unit 502 or the parallel processor 500 decodes and generates tokens associated at least with a first layer of an LLM, pre-fetch circuitry 580 can prefetch data associated with one or more subsequent kernels of the LLM into a buffer (not shown), as described herein. Parallel processing unit 502 or the parallel processor 500 can decode the prefetched data from the buffer to generate tokens.

FIG. 5B is a block diagram of a partition unit 520. The partition unit 520 may be an instance of one of the partition units 520A-520N of FIG. 5A. As illustrated, the partition unit 520 includes an L2 cache 521, a frame buffer interface 525, and a ROP 526 (raster operations unit). The L2 cache 521 is a read/write cache that is configured to perform load and store operations received from the memory crossbar 516 and ROP 526. Read misses and urgent write-back requests are output by L2 cache 521 to frame buffer interface 525 for processing. Updates can also be sent to the frame buffer via the frame buffer interface 525 for processing. In one embodiment the frame buffer interface 525 interfaces with one of the memory units in parallel processor memory, such as the memory units 524A-524N of FIG. 5A (e.g., within parallel processor memory 522). The partition unit 520 may additionally or alternatively also interface with one of the memory units in parallel processor memory via a memory controller (not shown).

In graphics applications, the ROP 526 is a processing unit that performs raster operations such as stencil, z test, blending, and the like. The ROP 526 then outputs processed graphics data that is stored in graphics memory. In some embodiments the ROP 526 includes or couples with a CODEC 527 that includes compression logic to compress depth or color data that is written to memory or the L2 cache 521 and decompress depth or color data that is read from memory or the L2 cache 521. The compression logic can be lossless compression logic that makes use of one or more of multiple compression algorithms. The type of compression that is performed by the CODEC 527 can vary based on the statistical characteristics of the data to be compressed. For example, in one embodiment, delta color compression is performed on depth and color data on a per-tile basis. In one embodiment the CODEC 527 includes compression and decompression logic that can compress and decompress compute data associated with machine learning operations. The CODEC 527 can, for example, compress sparse matrix data for sparse machine learning operations. The CODEC 527 can also compress sparse matrix data that is encoded in a sparse matrix format (e.g., coordinate list encoding (COO), compressed sparse row (CSR), compress sparse column (CSC), etc.) to generate compressed and encoded sparse matrix data. The compressed and encoded sparse matrix data can be decompressed and/or decoded before being processed by processing elements or the processing elements can be configured to consume compressed, encoded, or compressed and encoded data for processing.

The ROP 526 may be included within at least one processing cluster (e.g., cluster 514A-514N of FIG. 5A) instead of within the partition unit 520. In such embodiment, read and write requests for pixel data are transmitted over the memory crossbar 516 instead of pixel fragment data. The processed graphics data may be displayed on a display device, such as one of the one or more display device(s), routed for further processing by processor(s), or routed for further processing by one of the processing entities within a parallel processor 500.

FIG. 5C is a block diagram of a processing cluster 514 within a parallel processing unit. For example, the processing cluster is an instance of one of the processing clusters 514A-514N of FIG. 5A. The processing cluster 514 can be configured to execute many threads in parallel, where the term “thread” refers to an instance of a particular program executing on a particular set of input data. Optionally, single-instruction, multiple-data (SIMD) instruction issue techniques may be used to support parallel execution of a large number of threads without providing multiple independent instruction units. Alternatively, single-instruction, multiple-thread (SIMT) techniques may be used to support parallel execution of a large number of generally synchronized threads, using a common instruction unit configured to issue instructions to a set of processing engines within at least one of the processing clusters. Unlike a SIMD execution regime, where all processing engines typically execute identical instructions, SIMT execution allows different threads to more readily follow divergent execution paths through a given thread program. Persons skilled in the art will understand that a SIMD processing regime represents a functional subset of a SIMT processing regime.

Operation of the processing cluster 514 can be controlled via a pipeline manager 532 that distributes processing tasks to SIMT parallel processors. The pipeline manager 532 receives instructions from the scheduler 510 of FIG. 5A and manages execution of those instructions via a graphics multiprocessor 534 and/or a texture unit 536. The illustrated graphics multiprocessor 534 is an exemplary instance of a SIMT parallel processor. However, various types of SIMT parallel processors of differing architectures may be included within the processing cluster 514. One or more instances of the graphics multiprocessor 534 can be included within a processing cluster 514. The graphics multiprocessor 534 can process data and a data crossbar 540 can be used to distribute the processed data to one of multiple possible destinations, including other shader units. The pipeline manager 532 can facilitate the distribution of processed data by specifying destinations for processed data to be distributed via the data crossbar 540.

At least one of graphics multiprocessor 534 within the processing cluster 514 can include an identical set of functional execution logic (e.g., arithmetic logic units, load-store units, etc.). The functional execution logic can be configured in a pipelined manner in which new instructions can be issued before previous instructions are complete. The functional execution logic supports a variety of operations including integer and floating-point arithmetic, comparison operations, Boolean operations, bit-shifting, and computation of various algebraic functions. The same functional-unit hardware could be leveraged to perform different operations and any combination of functional units may be present.

The instructions transmitted to the processing cluster 514 constitute a thread. A set of threads executing across the set of parallel processing engines is a thread group. A thread group executes the same program on different input data. At least one thread within a thread group can be assigned to a different processing engine within a graphics multiprocessor 534. A thread group may include fewer threads than the number of processing engines within the graphics multiprocessor 534. When a thread group includes fewer threads than the number of processing engines, one or more of the processing engines may be idle during cycles in which that thread group is being processed. A thread group may also include more threads than the number of processing engines within the graphics multiprocessor 534. When the thread group includes more threads than the number of processing engines within the graphics multiprocessor 534, processing can be performed over consecutive clock cycles. Optionally, multiple thread groups can be executed concurrently on the graphics multiprocessor 534.

The graphics multiprocessor 534 may include an internal cache memory to perform load and store operations. Optionally, the graphics multiprocessor 534 can forego an internal cache and use a cache memory (e.g., level 1 (L1) cache 548) within the processing cluster 514. At least one graphics multiprocessor 534 also has access to level 2 (L2) caches within the partition units (e.g., partition units 520A-520N of FIG. 5A) that are shared among all processing clusters 514 and may be used to transfer data between threads. The graphics multiprocessor 534 may also access off-chip global memory, which can include one or more of: local parallel processor memory and/or system memory. Any memory external to the parallel processing unit 502 may be used as global memory. Embodiments in which the processing cluster 514 includes multiple instances of the graphics multiprocessor 534 can share common instructions and data, which may be stored in the L1 cache 548.

At least one processing cluster 514 may include an MMU 545 (memory management unit) that is configured to map virtual addresses into physical addresses. In other embodiments, one or more instances of the MMU 545 may reside within the memory interface 518 of FIG. 5A. The MMU 545 includes a set of page table entries (PTEs) used to map a virtual address to a physical address of a tile and optionally a cache line index. The MMU 545 may include address translation lookaside buffers (TLB) or caches that may reside within the graphics multiprocessor 534 or the L1 cache 548 of processing cluster 514. The physical address is processed to distribute surface data access locality to allow efficient request interleaving among partition units. The cache line index may be used to determine whether a request for a cache line is a hit or miss.

In graphics and computing applications, a processing cluster 514 may be configured such that at least one graphics multiprocessor 534 is coupled to a texture unit 536 for performing texture mapping operations, e.g., determining texture sample positions, reading texture data, and filtering the texture data. Texture data is read from an internal texture L1 cache (not shown) or in some embodiments from the L1 cache within graphics multiprocessor 534 and is fetched from an L2 cache, local parallel processor memory, or system memory, as needed. At least one graphics multiprocessor 534 outputs processed tasks to the data crossbar 540 to provide the processed task to another processing cluster 514 for further processing or to store the processed task in an L2 cache, local parallel processor memory, or system memory via the memory crossbar 516. A preROP 542 (pre-raster operations unit) is configured to receive data from graphics multiprocessor 534, direct data to ROP units, which may be located with partition units as described herein (e.g., partition units 520A-520N of FIG. 5A). The preROP 542 unit can perform optimizations for color blending, organize pixel color data, and perform address translations.

It will be appreciated that the core architecture described herein is illustrative and that variations and modifications are possible. Any number of processing units, e.g., graphics multiprocessor 534, texture units 536, preROPs 542, etc., may be included within a processing cluster 514. Further, while only one processing cluster 514 is shown, a parallel processing unit as described herein may include any number of instances of the processing cluster 514. Optionally, at least one processing cluster 514 can be configured to operate independently of other processing clusters 514 using separate and distinct processing units, L1 caches, L2 caches, etc.

FIG. 5D shows an example of the graphics multiprocessor 534 in which the graphics multiprocessor 534 couples with the pipeline manager 532 of the processing cluster 514. The graphics multiprocessor 534 has an execution pipeline including but not limited to an instruction cache 552, an instruction unit 554, an address mapping unit 556, a register file 558, one or more general purpose graphics processing unit (GPGPU) cores 562, and one or more load/store units 566. The GPGPU cores 562 and load/store units 566 are coupled with cache memory 572 and shared memory 570 via a memory and cache interconnect 568. The graphics multiprocessor 534 may additionally include tensor and/or ray-tracing cores 563 that include hardware logic to accelerate matrix and/or ray-tracing operations.

The instruction cache 552 may receive a stream of instructions to execute from the pipeline manager 532. The instructions are cached in the instruction cache 552 and dispatched for execution by the instruction unit 554. The instruction unit 554 can dispatch instructions as thread groups (e.g., warps), with at least one thread of the thread group assigned to a different execution unit within GPGPU core 562. An instruction can access a local, shared, or global address space by specifying an address within a unified address space. The address mapping unit 556 can be used to translate addresses in the unified address space into a distinct memory address that can be accessed by the load/store units 566.

The register file 558 provides a set of registers for the functional units of the graphics multiprocessor 534. The register file 558 provides temporary storage for operands connected to the data paths of the functional units (e.g., GPGPU cores 562, load/store units 566) of the graphics multiprocessor 534. The register file 558 may be divided between at least one of the functional units such that at least one functional unit is allocated a dedicated portion of the register file 558. For example, the register file 558 may be divided between the different warps being executed by the graphics multiprocessor 534.

The GPGPU cores 562 can include floating point units (FPUs) and/or integer arithmetic logic units (ALUs) that are used to execute instructions of the graphics multiprocessor 534. In some implementations, the GPGPU cores 562 can include hardware logic that may otherwise reside within the tensor and/or ray-tracing cores 563. The GPGPU cores 562 can be similar in architecture or can differ in architecture. For example and in one embodiment, a first portion of the GPGPU cores 562 include a single precision FPU and an integer ALU while a second portion of the GPGPU cores include a double precision FPU. Optionally, the FPUs can implement the IEEE 154-2008 standard for floating point arithmetic or enable variable precision floating point arithmetic. The graphics multiprocessor 534 can additionally include one or more fixed function or special function units to perform specific functions such as copy rectangle or pixel blending operations. One or more of the GPGPU cores can also include fixed or special function logic.

The GPGPU cores 562 may include SIMD logic capable of performing a single instruction on multiple sets of data. Optionally, GPGPU cores 562 can physically execute SIMD4, SIMD8, and SIMD16 instructions and logically execute SIMD1, SIMD2, and SIMD32 instructions. The SIMD instructions for the GPGPU cores can be generated at compile time by a shader compiler or automatically generated when executing programs written and compiled for single program multiple data (SPMD) or SIMT architectures. Multiple threads of a program configured for the SIMT execution model can be executed via a single SIMD instruction. For example and in one embodiment, eight SIMT threads that perform the same or similar operations can be executed in parallel via a single SIMD8 logic unit.

During processing of a layer of data, pre-fetch circuitry 580 can prefetch data of one or more subsequent kernels into layer buffer 582.

The memory and cache interconnect 568 is an interconnect network that connects at least one of the functional units of the graphics multiprocessor 534 to the register file 558 and to the shared memory 570. For example, the memory and cache interconnect 568 is a crossbar interconnect that allows the load/store unit 566 to implement load and store operations between the shared memory 570 and the register file 558. The register file 558 can operate at the same frequency as the GPGPU cores 562, thus data transfer between the GPGPU cores 562 and the register file 558 is very low latency. The shared memory 570 can be used to enable communication between threads that execute on the functional units within the graphics multiprocessor 534. The cache memory 572 can be used as a data cache for example, to cache texture data communicated between the functional units and the texture unit 536. The shared memory 570 can also be used as a program managed cached. The shared memory 570 and the cache memory 572 can couple with the data crossbar 540 to enable communication with other components of the processing cluster. Threads executing on the GPGPU cores 562 can programmatically store data within the shared memory in addition to the automatically cached data that is stored within the cache memory 572.

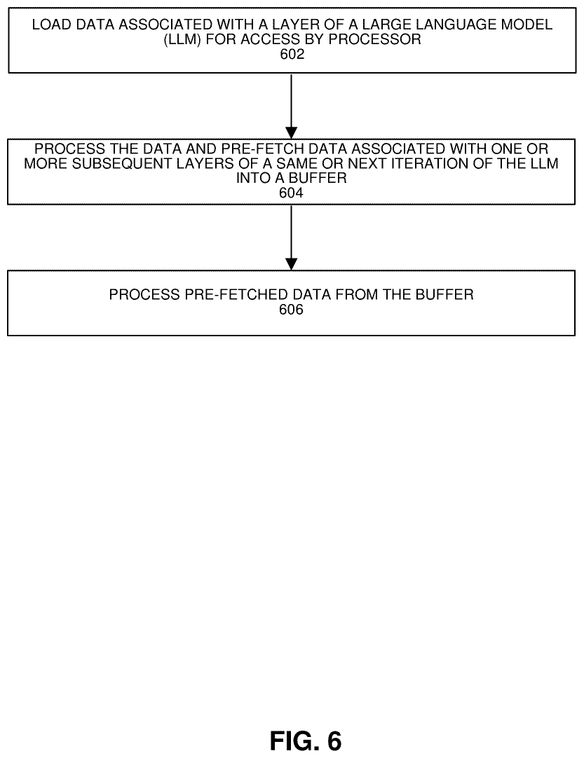

FIG. 6 depicts an example process. The process can be performed by a processor or other circuitry. At 602, the process can load data associated with a kernel of an LLM into a buffer or a cache associated with a processor. For example, the buffer can be allocated in a memory device, MSC, or a cache. The data can include constant weight values and key value entries associated with a first transformer block of an LLM neural network.

At 604, the process can cause the processor to process the data to generate a token for the kernel of the LLM and store the generated token into a cache and cause a prefetch of data associated with one or more subsequent kernels of the LLM. The prefetched data can be stored in the buffer, MSC, or the cache. The prefetched data can include constant weight values and key value entries associated with a second or subsequent transformer block of the LLM neural network. Processing the data can include performance of an attention kernel and a feed forward kernel.

At 606, the process can cause the processor to process the prefetched data to generate a token and store the generated token into a KV cache. Processing the pre-fetched data can include performance of an attention kernel and a feed forward kernel.

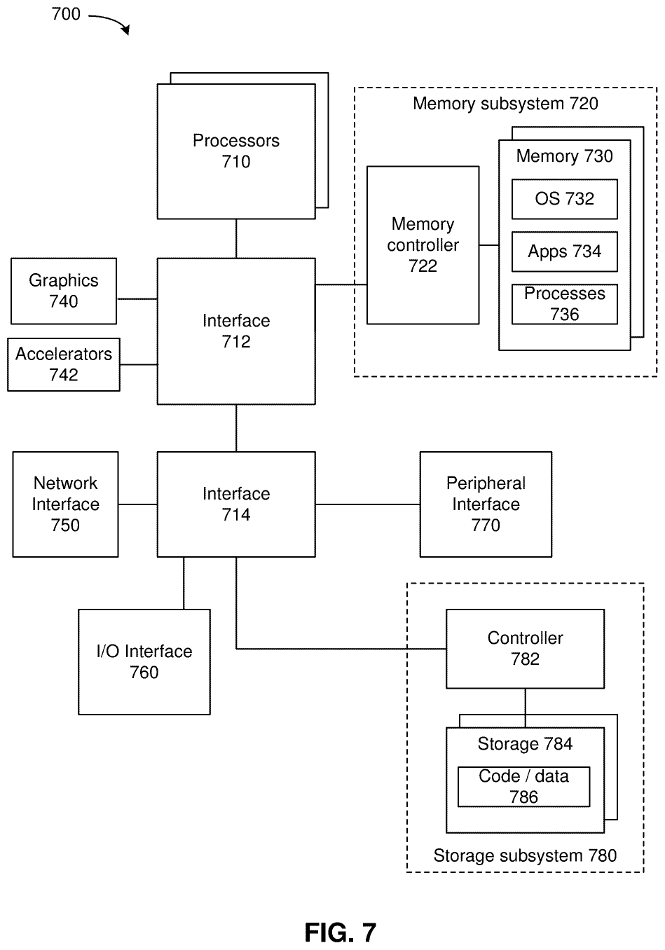

FIG. 7 depicts a system. In some examples, circuitry of system 700 can prefetch data used in an LLM, while processing data, and subsequently process the prefetched data, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 732, a system administrator, and/or orchestrator can enable or disable prefetching of data used in an LLM, while processing data, and subsequently processing the prefetched data from a prefetch buffer, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), RoCE v2, Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 700 can be implemented using interconnected compute platforms of processors, memories, storages, network interfaces, and other components. High speed interconnects can be used such as PCIe, CXL, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.’”

Illustrative examples of the devices, systems, and methods disclosed herein are provided below. An embodiment of the devices, systems, and methods may include any one or more, and any combination of, the examples described below.

An example includes a processor to process constant weight values and key value entries associated with a first transformer block of a large language model (LLM) neural network and circuitry to pre-fetch constant weight values and key value entries associated with a second transformer block of the LLM neural network into a buffer before processing of the constant weight values and key value entries associated with the second transformer block of the LLM neural network by the processor, wherein the processor is to process the pre-fetched constant weight values and key value entries from the buffer.

Example 1 includes one or more examples and includes an apparatus that includes a processor to process constant weight values and key value entries associated with a first transformer kernel of a large language model (LLM) neural network and a circuitry to: during processing of the constant weight values and key value entries associated with the first transformer kernel of the LLM neural network, pre-fetch constant weight values and key value entries associated with a second transformer kernel of the LLM neural network into a buffer, wherein: the first transformer kernel is to provide inputs to the second transformer kernel and the circuitry is to process the pre-fetched constant weight values and the key value entries associated with the second transformer kernel of the LLM neural network from the buffer.

Example 2 includes one or more examples, wherein the processing of the constant weight values and key value entries associated with the first transformer kernel of the LLM neural network comprises performance of an attention kernel and a feed forward kernel.

Example 3 includes one or more examples, wherein the process the pre-fetched constant weight values and the key value entries associated with the second transformer kernel of the LLM neural network from the buffer is to occur during an attention phase.

Example 4 includes one or more examples, wherein the processing of the constant weight values and key value entries associated with the first transformer kernel of the LLM neural network comprises accessing context stored in a key value cache to generate tokens and updating the context in the key value cache.

Example 5 includes one or more examples, wherein the buffer comprises one or more of: scratch pad memory space, last level cache (LLC), or a memory-side-cache (MSC).

Example 6 includes one or more examples, wherein the pre-fetch constant weight values and key value entries associated with a second transformer kernel of the LLM neural network into the buffer comprises copy the constant weight values and key value entries associated with the second transformer block of the LLM neural network from a memory into the buffer.

Example 7 includes one or more examples, wherein the processor comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

Example 8 includes one or more examples, and includes at least one non-transitory computer-readable medium comprising instructions stored thereon, that if executed by one or more processors, cause the one or more processors to: execute a driver that is to configure a circuitry of a processor to: during processing of constant weight values and key value entries associated with a first transformer kernel of a large language model (LLM) neural network, pre-fetch constant weight values and key value entries associated with a second transformer kernel of the LLM neural network into a buffer and process the pre-fetched constant weight values and the key value entries associated with the second transformer kernel of the LLM neural network from the buffer.

Example 9 includes one or more examples, wherein the processing of the constant weight values and key value entries associated with the first transformer kernel of the LLM neural network comprises performance of an attention kernel and a feed forward kernel.

Example 10 includes one or more examples, wherein the process the pre-fetched constant weight values and the key value entries associated with the second transformer kernel of the LLM neural network from the buffer occurs during an attention phase.

Example 11 includes one or more examples, wherein the processing of the constant weight values and key value entries associated with the first transformer kernel of the LLM neural network comprises accessing context stored in a key value cache to generate tokens and updating the context in the key value cache.

Example 12 includes one or more examples, wherein the buffer comprises one or more of: scratch pad memory space, last level cache (LLC), or a memory-side-cache (MSC).

Example 13 includes one or more examples, wherein the pre-fetch constant weight values and key value entries associated with a second transformer kernel of the LLM neural network into the buffer comprises copy the constant weight values and key value entries associated with the second transformer kernel of the LLM neural network from a memory into the buffer.

Example 14 includes one or more examples, wherein the processor comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

Example 15 includes one or more examples, and includes a method that includes: during processing of constant weight values and key value entries associated with a first transformer kernel of a large language model (LLM) neural network, pre-fetching constant weight values and key value entries associated with a second transformer kernel of the LLM neural network into a buffer and processing the pre-fetched constant weight values and the key value entries associated with the second transformer kernel of the LLM neural network from the buffer.

Example 16 includes one or more examples, wherein the processing of the constant weight values and key value entries associated with the first transformer kernel of the LLM comprises performance of an attention kernel and a feed forward kernel.

Example 17 includes one or more examples, wherein the processing the pre-fetched constant weight values and the key value entries associated with at least one other transformer kernel of the LLM neural network from the buffer is to occur during an attention phase.

Example 18 includes one or more examples, wherein the processing constant weight values and key value entries associated with the first transformer kernel of the LLM neural network comprises accessing context stored in a key value cache to generate tokens and updating the context in the key value cache.

Example 19 includes one or more examples, wherein the buffer comprises one or more of: scratch pad memory space, last level cache (LLC), or a memory-side-cache (MSC).

Example 20 includes one or more examples, wherein processor comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

1. An apparatus comprising:
a processor to process constant weight values and key value entries associated with a first transformer kernel of a large language model (LLM) neural network and
a circuitry to: during processing of the constant weight values and key value entries associated with the first transformer kernel of the LLM neural network, pre-fetch constant weight values and key value entries associated with a second transformer kernel of the LLM neural network into a buffer, wherein:
the first transformer kernel is to provide inputs to the second transformer kernel and
the circuitry is to process the pre-fetched constant weight values and the key value entries associated with the second transformer kernel of the LLM neural network from the buffer.

2. The apparatus of claim 1, wherein the processing of the constant weight values and key value entries associated with the first transformer kernel of the LLM neural network comprises performance of an attention kernel and a feed forward kernel.

3. The apparatus of claim 1, wherein the process the pre-fetched constant weight values and the key value entries associated with the second transformer kernel of the LLM neural network from the buffer is to occur during an attention phase.

4. The apparatus of claim 1, wherein the processing of the constant weight values and key value entries associated with the first transformer kernel of the LLM neural network comprises accessing context stored in a key value cache to generate tokens and updating the context in the key value cache.

5. The apparatus of claim 1, wherein the buffer comprises one or more of: scratch pad memory space, last level cache (LLC), or a memory-side-cache (MSC).

6. The apparatus of claim 1, wherein the pre-fetch constant weight values and key value entries associated with a second transformer kernel of the LLM neural network into the buffer comprises copy the constant weight values and key value entries associated with the second transformer block of the LLM neural network from a memory into the buffer.

7. The apparatus of claim 1, wherein the processor comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

8. At least one non-transitory computer-readable medium comprising instructions stored thereon, that if executed by one or more processors, cause the one or more processors to:
execute a driver that is to configure a circuitry of a processor to:
during processing of constant weight values and key value entries associated with a first transformer kernel of a large language model (LLM) neural network, pre-fetch constant weight values and key value entries associated with a second transformer kernel of the LLM neural network into a buffer and
process the pre-fetched constant weight values and the key value entries associated with the second transformer kernel of the LLM neural network from the buffer.

9. The at least one non-transitory computer-readable medium of claim 8, wherein the processing of the constant weight values and key value entries associated with the first transformer kernel of the LLM neural network comprises performance of an attention kernel and a feed forward kernel.

10. The at least one non-transitory computer-readable medium of claim 8, wherein the process the pre-fetched constant weight values and the key value entries associated with the second transformer kernel of the LLM neural network from the buffer occurs during an attention phase.

11. The at least one non-transitory computer-readable medium of claim 8, wherein the processing of the constant weight values and key value entries associated with the first transformer kernel of the LLM neural network comprises accessing context stored in a key value cache to generate tokens and updating the context in the key value cache.

12. The at least one non-transitory computer-readable medium of claim 8, wherein the buffer comprises one or more of: scratch pad memory space, last level cache (LLC), or a memory-side-cache (MSC).

13. The at least one non-transitory computer-readable medium of claim 8, wherein the pre-fetch constant weight values and key value entries associated with a second transformer kernel of the LLM neural network into the buffer comprises copy the constant weight values and key value entries associated with the second transformer kernel of the LLM neural network from a memory into the buffer.

14. The at least one non-transitory computer-readable medium of claim 8, wherein the processor comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.

15. A method comprising:
during processing of constant weight values and key value entries associated with a first transformer kernel of a large language model (LLM) neural network, pre-fetching constant weight values and key value entries associated with a second transformer kernel of the LLM neural network into a buffer and
processing the pre-fetched constant weight values and the key value entries associated with the second transformer kernel of the LLM neural network from the buffer.

16. The method of claim 15, wherein the processing of the constant weight values and key value entries associated with the first transformer kernel of the LLM comprises performance of an attention kernel and a feed forward kernel.

17. The method of claim 15, wherein the processing the pre-fetched constant weight values and the key value entries associated with at least one other transformer kernel of the LLM neural network from the buffer is to occur during an attention phase.

18. The method of claim 15, wherein the processing constant weight values and key value entries associated with the first transformer kernel of the LLM neural network comprises accessing context stored in a key value cache to generate tokens and updating the context in the key value cache.

19. The method of claim 15, wherein the buffer comprises one or more of: scratch pad memory space, last level cache (LLC), or a memory-side-cache (MSC).

20. The method of claim 15, wherein processor comprises one or more of: a central processing unit (CPU), graphics processing unit (GPU), general purpose GPU, neural processing unit (NPU), application specific integrated circuit (ASIC), tensor processing unit (TPU), matrix math unit (MMU), memory, cache, or an accelerator.
